(19) United States
(12) Patent Application Publication
(10) Pub. No.: US 2004/0068004 A1
(43) Pub. Date: Apr. 8, 2004

(54) Use of oxabicyclo[2.2.1]heptadiene derivatives as pesticidal agents

(76) Inventors: Ernst Rudolf F. Gesing, Hochdahl (DE); Christoph Erdelen, Leichlingen (DE); Gerd Hanssler, Leverkeusen (DE); Karl-Heinz Kuck, Langenfeld (DE); Peter Losel, Leverkeusen (DE); Wolfram Andersch, Bergisch (DE); Yi-Mei Xu, Shanghai (CN); Liang Chen, Shanghai (CN); Qinghong Tang, Shanghai (CN); Jin Cao, Shanghai (CN)

Correspondence Address: Bayer Cropscience, Patent Department, 100 Bayer Road, Pittsburgh, PA, 15205-9741, US

(21) Appl. No.: 10/250,330

(22) PCT Filed: Dec. 19, 2001
(86) PCT No.: PCT/EP01/15003

(30) Foreign Application Priority Data
Jan. 3, 2001 (CN) 01-01355.9

(51) Int. Cl. A01N 43/08

(52) U.S. Cl. 514/469

(57) ABSTRACT

7-oxabicyclo[2.2.1]heptadiene derivatives of formula (I) in which R¹ and R², independently of one another, represent hydrogen or methyl and R³ represents a group selected from —OR⁴; —SR⁵ and —NH—R⁶, wherein R⁴, R⁵ and R⁶ independently of one another, represent hydrogen, alkyl, optionally substituted aryl, optionally substituted aralkyl, optionally substituted heterocyclyl or optionally substituted heterocyclylalkyl, are very suitable for controlling undesired microorganisms and animal pests. New 7-oxabicyclo[2.2.1]heptadiene derivatives of formula (I) in which R³ represents a group selected from —SR⁵ and —NH—R⁶.

The present invention relates to the new use of certain 7-oxabicyclo[2.2.1]-heptadiene derivatives for controlling undesired microorganisms and animal pests.

Various 7-oxabicyclo[2.2.1]heptadiene derivatives are already known from the art. Thus, 7-oxabicyclo[2.2.1]hepta-2,5-diene-2,3-dicarboxylic acid bis[(4-methoxyphenyl)-methyl]-ester has been described as a chemical compound. A microbicidal or other pesticidal activity of such compounds, however, has not been disclosed until now.

It has now been found that 7-oxabicyclo[2.2.1]heptadiene derivatives of the formula

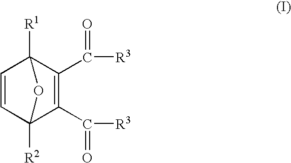

in which

R¹ and R², independently of one another, represent hydrogen or methyl and

R³ represents a group selected from OR⁴, —SR⁵ and —NH—R⁶,

wherein

R⁴, R⁵ and R⁶ independently of one another, represent hydrogen, alkyl, optionally substituted aryl, optionally substituted aralkyl, optionally substituted heterocyclyl or optionally substituted heterocyclylalkyl;

are very suitable for controlling undesired microorganisms and animal pests.

Surprisingly, the compounds according to the invention show a markedly better activity against undesired microorganisms and animal pests than the constitutionally most similar compounds which are known from the prior art.

Depending on the nature of the substituents, the 7-oxabicyclo[2.2.1]heptandiene derivatives of the formula (I) can be present as geometrical and/or optical isomers or as mixtures of such isomers. The invention relates to both, the pure isomers and mixtures of isomers.

Formula (I) provides a general definition of the 7-oxabicyclo[2.2.1]heptadiene derivatives, which can be used according to the invention.

R¹ preferably represents hydrogen or methyl.

R² preferably represents hydrogen or methyl.

R³ preferably represents a group selected from —OR⁴, —SR⁵ and —NH—R⁶,

wherein

R⁴ preferably represents hydrogen, straight-chain or branched alkyl having 1 to 8 carbon atoms,

or

R⁴ preferably represents aryl having 6 to 10 carbon atoms, wherein each of these groups may be mono- to tri-substituted by identical or different radicals selected from the group consisting of halogen, nitro, cyano, aminocarbonylamino, alkyl having 1 to 6 carbon atoms, halo-genoalkyl having 1 to 6 carbon atoms and 1 to 5 identical or different halogen atoms, alkoxy having 1 to 6 carbon atoms, halogenoalkoxy having 1 to 6 carbon atoms and 1 to 5 identical or different halogen atoms, cycloalkyl having 3 to 8 carbon atoms, phenyl and phenoxy,

or

R⁴ preferably represents arylalkyl having 6 to 10 carbon atoms in the aryl group and 1 to 6 carbon atoms in the alkyl group, wherein each of these groups may be mono- to tri-substituted by identical of different radicals selected from the group consisting of halogen, nitro, cyano, alkyl having 1 to 6 carbon atoms, halogenoalkyl having 1 to 6 carbon atoms and 1 to 5 identical or different halogen atoms, alkoxy having 1 to 6 carbon atoms, halogenoalkoxy having 1 to 6 carbon atoms and 1 to 5 identical or different halogen atoms, cycloalkyl having 3 to 8 carbon atoms, phenyl and phenoxy,

or

R⁴ preferably represents 5 or 6-membered heterocyclyl having 1 to 3 heteroatoms, such as nitrogen, sulphur and/or oxygen, wherein the heterocyclic groups may be benzo-annellated and may be mono- to tri-substituted by identical or different radicals selected from the group consisting of halogen, nitro, alkoxycarbonyl comprising 1 to 6 carbon atoms in the alkoxy group, cyano, alkyl having 1 to 6 carbon atoms, halogenoalkyl having 1 to 6 carbon atoms and 1 to 5 identical or different halogen atoms, alkoxy having 1 to 6 carbon atoms, halogenoalkoxy having 1 to 6 carbon atoms and 1 to 5 identical or different halogen atoms, cycloalkyl having 3 to 8 carbon atoms, phenyl and phenoxy,

or

R⁴ preferably represents 5- or 6-membered heterocyclylalkyl having 1 to 6 carbon atoms in the alkyl group and 1 to 3 heteroatoms, such as nitrogen, sulphur and/or oxygen, in the heterocyclyl group, wherein the heterocyclyl groups may be benzo-annellated and may be mono- to tri-substituted by identical or different radicals selected from the group consisting of halogen, nitro, alkoxycabonyl comprising 1 to 6 carbon atoms in the alkoxy group, cyano, alkyl having 1 to 6 carbon atoms, halogenoalkyl having 1 to 6 carbon atoms and 1 to 5 identical or different halogen atoms, alkoxy having 1 to 6 carbon atoms, halogenoalkoxy having 1 to 6 carbon atoms and 1 to 5 identical or different halogen atoms, cycloalkyl having 3 to 8 carbon atoms, phenyl and phenoxy,

R⁵ preferably represents hydrogen straight-chain or branched alkyl having 1 to 8 carbon atoms,

or

R⁵ preferably represents aryl having 6 to 10 carbon atoms, wherein each of these groups may be mono- to tri-substituted by identical or different radicals selected from the group consisting of halogen, nitro, cyano, aminocarbonylamino, alkyl having 1 to 6 carbon atoms, halogenoalkyl having 1 to 6 carbon atoms and 1 to 5 identical or different halogen atoms, alkoxy having 1 to 6 carbon atoms, halogenoalkoxy having 1 to 6 carbon atoms and 1 to 5 identical or different halogen atoms, cycloalkyl having 3 to 8 carbon atoms' phenyl and phenoxy,

or

R⁵ preferably represents arylalkyl having 6, to 10 carbon atoms in the aryl group and 1 to 6 carbon atoms in the alkyl group, wherein each of these groups may be mono- to tri-substituted by identical or different radicals selected from the group consisting of halogen, nitro, cyano, alkyl having 1 to 6 carbon atoms, halogenoalkyl having 1 to 6 carbon atoms and 1 to 5 identical or different halogen atoms, alkoxy having 1 to 6 carbon atoms, halogenoalkoxy having 1 to 6 carbon atoms and 1 to 5 identical or different halogen atoms, cycloalkyl having 3 to 8 carbon atoms, phenyl and phenoxy,

or

R⁵ preferably represents 5- or 6-membered heterocyclyl having 1 to 3 heteroatoms, such as nitrogen, sulphur and/or oxygen, wherein the heterocyclic group may be benzo-annellated and may be mono- to tri-substituted by identical or different radicals selected from the group consisting of halogen, nitro, alkoxycarbonyl comprising 1 to 6 carbon atoms in the alkoxy group, cyano, alkyl having 1 to 6 carbon atoms, halogenoalkyl having 1 to 6 carbon atoms and 1 to 5 identical or different halogen atoms, alkoxy having 1 to 6 carbon atoms, halogenoalkoxy having 1 to 6 carbon atoms and 1 to 5 identical or different halogen atoms, cycloalkyl having 3 to 8 carbon atoms, phenyl and phenoxy,

or

R⁵ preferably represents 5- or 6-membered heterocyclylalkyl having 1 to 6 carbon atoms in the alkyl group and 1 to 3 heteroatoms, such as nitrogen, sulphur and/or oxygen, in the heterocyclyl group, wherein the heterocyclyl groups may be benzo-annellated and may be mono- to tri-substituted by identical or different radicals selected from the group consisting of halogen, nitro, alkoxycarbonyl comprising 1 to 6 carbon atoms in the alkoxy group, cyano, alkyl having 1 to 6 carbon atoms, halogenoalkyl having 1 to 6 carbon atoms and 1 to 5 identical or different halogen atoms, alkoxy having 1 to 6 carbon atoms, halogenoalkoxy having 1 to 6 carbon atoms and 1 to 5 identical or different halogen atoms, cycloalkyl having 3 to 8 carbon atoms, phenyl and phenoxy,

and

R⁶ preferably represents hydrogen, straight-chain or branched alkyl having 1 to 8 carbon atoms,

or

R⁶ preferably represents aryl having 6 to 10 carbon atoms, wherein each of these groups may be mono- to tri-substituted by identical or different radicals selected from the group consisting of halogen, nitro, cyano, aminocarbonylamino, alkyl having 1 to 6 carbon atoms, halogenoalkyl having 1 to 6 carbon atoms and 1 to 5 identical or different halogen atoms, alkoxy having 1 to 6 carbon atoms, halogenoalkoxy having 1 to 6 carbon atoms and 1 to 5 identical or different halogen atoms, cycloalkyl having 3 to 8 carbon atoms, phenyl and phenoxy,

or

R⁶ preferably represents arylalkyl having 6 to 10 carbon atoms in the aryl group and 1 to 6 carbon atoms in the alkyl group, wherein each of these groups may be mono- to tri-substituted by identical or different radicals selected from the group consisting of halogen, nitro, cyano, alkyl having 1 to 6 carbon atoms, halogenoalkyl having 1 to 6 carbon atoms and 1 to 5 identical or different halogen atoms, alkoxy having 1 to 6 carbon atoms, halogenoalkoxy having 1 to 6 carbon atoms and 1 to 5 identical or different halogen atoms, cycloalkyl having 3 to 8 carbon atoms, phenyl and phenoxy,

or

R⁶ preferably represents 5- or 6-membered heterocyclyl having 1 to 3 heteroatoms, such as nitrogen, sulphur and/or oxygen, wherein the heterocyclic group may be benzo-annellated and may be mono- to tri-substituted by identical of different radicals selected from the group consisting of halogen, nitro, alkoxycarbonyl comprising 1 to 6 carbon atoms in the alkoxy group, cyano, alkyl having 1 to 6 carbon atoms, halogenoalkyl having 1 to 6 carbon atoms and 1 to 5 identical or different halogen atoms, alkoxy having 1 to 6 carbon atoms, halogenoalkoxy having 1 to 6 carbon atoms and 1 to 5 identical or different halogen atoms, cycloalkyl having 3 to 8 carbon atoms, phenyl and phenoxy,

or

R⁶ preferably represents 5- or 6-membered heterocyclylalkyl having 1 to 6 carbon atoms in the alkyl group and 1 to 3 heteroatoms, such as nitrogen, sulphur and/or oxygen, in the heterocyclyl group wherein the heterocyclyl groups may be benzo-annellated and may be mono- to tri-substituted by identical or different radicals selected from the group consisting of halogen, nitro, alkoxycarbonyl comprising 1 to 6 carbon atoms in the alkoxy group, cyano, alkyl having 1 to 6 carbon atoms, halogenoalkyl having 1 to 6 carbon atoms and 1 to 5 identical or different halogen atoms, alkoxy having 1 to 6 carbon atoms, halogenoalkoxy having 1 to 6 carbon atoms and 1 to 5 identical or different halogen atoms, cycloalkyl having 3 to 8 carbon atoms, phenyl and phenoxy.

Particularly preferred are 7-oxabicyclo[2.2.1]heptadiene derivatives of the formula (I), in which

R¹ represents hydrogen or methyl,

R² represents hydrogen or methyl,

R³ represents a group selected from —OR⁴, —SR⁵ and —NH—R⁶, wherein

R⁴ represents hydrogen or straight-chain or branched alkyl having 1 to 6 carbon atoms,

or

R⁴ represents phenyl, which may be mono- to tri-substituted by identical or different radicals selected from the group consisting of fluorine, chlorine, bromine, nitro, cyano, aminocarbonylamino, alkyl having 0.1 to 4 carbon atoms, halogenoalkyl having 1 to 4 carbon atoms and 1 to 5 fluorine, chlorine and/or bromine atoms, alkoxy having 1 to 4 carbon atoms, halogenoalkoxy having 1 to 4 carbon atoms and 1 to 5 fluorine, chlorine and/or bromine atoms, cycloalkyl having 3 to 7 carbon atoms, phenyl and phenoxy,

or

R⁴ represents phenylalkyl having 1 to 4 carbon atoms in the alkyl group, wherein the phenyl group may be mono to tri-substituted by identical or different radicals selected from the group consisting of fluorine, chlorine, bromine, nitro, cyano, alkyl having 1 to 4 carbon atoms, halogenoalkyl having 1 to 4 carbon atoms and 1 to 5 fluorine, chlorine and/or bromine atoms, alkoxy having 1 to 4 carbon atoms, halogenoalkoxy having 1 to 4 carbon atoms and 1 to 5 fluorine, chlorine and/or bromine atoms, cycloalkyl having 3 to 7 carbon atoms, phenyl and phenoxy,

or

R⁴ represents 5- or 6-membered heterocyclyl having 1 to 3 heteroatoms, such as nitrogen, sulphur and/or oxygen, wherein the heterocyclyl groups may be benzo-annellated and may be mono- to tri-substituted by identical or different radicals selected from the group consisting of fluorine, chlorine, bromine, nitro, alkoxycarbonyl comprising 1 to 4 carbon atoms in the alkoxy group, cyano, alkyl having 1 to 4 carbon atoms, halogenoalkyl having 1 to 4 carbon atoms and 1 to 5 fluorine, chlorine and/or bromine atoms, alkoxy having 1 to 4 carbon atoms, halogenoalkoxy having 1 to 4 carbon atoms and 1 to 5 fluorine, chlorine and/or bromine atoms, cycloalkyl having 3 to 7 carbon atoms, phenyl and phenoxy,

or

R⁴ represents 5- or 6-membered heterocyclylalkyl having 1 to 4 carbon atoms in the alkyl group and 1 to 3 heteroatoms, such as nitrogen, sulphur and/or oxygen, in the heterocyclyl group, wherein the heterocyclyl groups may be benzo-annellated and may be mono- to tri-substituted by identical or different radicals selected from the group consisting of fluorine, chlorine, bromine, nitro, alkoxycarbonyl comprising 1 to 4 carbon atoms in the alkoxy group, cyano, alkyl having 1 to 4 carbon atoms, halogenoalkyl having 1 to 4 carbon atoms and 1 to 5 fluorine, chlorine and/or bromine atoms, alkoxy having 1 to 4 carbon atoms, halogenoalkoxy having 1 to 4 carbon atoms and 1 to 5 fluorine, chlorine and/or bromine atoms, cycloalkyl having 3 to 7 carbon atoms, phenyl and phenoxy,

R⁵ represents hydrogen or straight-chain or branched alkyl having 1 to 6 carbon atoms,

or

R⁵ represents phenyl, which may be mono- to tri-substituted by identical or different radicals selected from the group consisting of fluorine, chlorine, bromine, nitro, cyano, aminocarbonylamino, alkyl having 1 to 4 carbon atoms, halogenoalkyl having 1 to 4 carbon atoms and 1 to 5 fluorine, chlorine and/or bromine atoms, alkoxy having 1 to 4 carbon atoms, halogenoalkoxy having 1 to 4 carbon atoms and 1 to 5 fluorine, chlorine and/or bromine atoms, cycloalkyl having 3 to 7 carbon atoms, phenyl and phenoxy,

or

R⁵ represents phenylalkyl having 1 to 4 carbon atoms in the alkyl group, wherein the phenyl group may be mono- to tri-substituted by identical or different radicals selected from the group consisting of fluorine, chlorine, bromine, nitro, cyano, alkyl having 1 to 4 carbon atoms, halogenoalkyl having 1 to 4 carbon atoms and 1 to 5 fluorine, chlorine and/or bromine atoms, alkoxy having 1 to 4 carbon atoms, halogenoalkoxy having 1 to 4 carbon atoms and 1 to 5 fluorine, chlorine and/or bromine atoms, cycloalkyl having 3 to 7 carbon atoms, phenyl and phenoxy,

or

R⁵ represents 5- or 6-membered heterocyclyl having 1 to 3 heteroatoms, such as nitrogen, sulphur and/or oxygen, wherein the heterocyclyl groups may be benzo-annellated and may be mono- to tri-substituted by identical or different radicals selected from the group consisting of fluorine, chlorine, bromine, nitro, alkoxycarbonyl comprising 1 to 4 carbon atoms in the alkoxy group, cyano, alkyl having 1 to 4 carbon atoms, halogenoalkyl having 1 to 4 carbon atoms and 1 to 5 fluorine, chlorine and/or bromine atoms, alkoxy having 1 to 4 carbon atoms, halogenoalkoxy having 1 to 4 carbon atoms and 1 to 5 fluorine, chlorine and/or bromine atoms, cycloalkyl having 3 to 7 carbon atoms, phenyl and phenoxy,

or

R⁵ represents 5- or 6-membered heterocyclylalkyl having 1 to 4 carbon atoms in the alkyl group and 1 to 3 heteroatoms, such as nitrogen, sulphur and/or oxygen, in the heterocyclyl group wherein the heterocyclyl groups may be benzo-annellated and may be mono- to tri-substituted by identical or different radicals selected from the group consisting of fluorine, chlorine, bromine, nitro, alkoxycarbonyl comprising 1 to 4 carbon atoms in the alkoxy group, cyano, alkyl having 1 to 4 carbon atoms, halogenoalkyl having 1 to 4 carbon atoms and 1 to 5 fluorine, chlorine and/or bromine atoms, alkoxy having 1 to 4 carbon atoms, halogenoalkoxy having 1 to 4 carbon atoms and 1 to 5 fluorine, chlorine and/or bromine atoms, cycloalkyl having 3 to 7 carbon atoms, phenyl and phenoxy,

and

R⁶ represents hydrogen or straight-chain or branched alkyl having 1 to 6 carbon atoms,

or

R⁶ represents phenyl, which may be mono- to tri-substituted by identical or different radicals selected from the group consisting of fluorine, chlorine, bromine, nitro, cyano, aminocarbonylamino, alkyl having 1 to 4 carbon atoms, halogenoalkyl having 1 to 4 carbon atoms and 1 to 5 fluorine, chlorine and/or bromine atoms, alkoxy having 1 to 4 carbon atoms, halogenoalkoxy having 1 to 4 carbon atoms and 1 to 5 fluorine, chlorine and/or bromine atoms, cycloalkyl having 3 to 7 carbon atoms, phenyl and phenoxy,

or

R⁶ represents phenylalkyl having 1 to 4 carbon atoms in the alkyl group, wherein the phenyl group may be mono- to tri-substituted by identical or different radicals selected from the group consisting of fluorine, chlorine, bromine, nitro, cyano, alkyl having 1 to 4 carbon atoms, halogenoalkyl having 1 to 4 carbon atoms and 1 to 5 fluorine, chlorine and/or bromine atoms, alkoxy having 1 to 4 carbon atoms, halogenoalkoxy having 1 to 4 carbon atoms and 1 to 5 fluorine, chlorine and/or bromine atoms, cycloalkyl having 3 to 7 carbon atoms, phenyl and phenoxy,

or

R⁶ represents 5- or 6-membered heterocyclyl having 1 to 3 heteroatoms, such as nitrogen, sulphur and/or oxygen, wherein the heterocyclyl groups may be benzo-annellated and may be mono- to tri-substituted by identical or different radicals selected from the group consisting of fluorine, chlorine, bromine, nitro, alkoxycarbonyl comprising 1 to 4 carbon atoms in the alkoxy group, cyano, alkyl having 1 to 4 carbon atoms, halogenoalkyl having 1 to 4 carbon atoms and 1 to 5 fluorine, chlorine and/or bromine atoms, alkoxy having 1 to 4 carbon atoms, halogenoalkoxy having 1 to 4 carbon atoms and 1 to 5 fluorine, chlorine and/or bromine atoms, cycloalkl having 3 to 7 carbon atoms, phenyl and phenoxy,

or

R⁶ represents 5- or 6-membered heterocyclylalkyl having 1 to 4 carbon atoms in the alkyl group and 1 to 3 heteroatoms, such as nitrogen, sulphur and/or oxygen, in the heterocyclyl group wherein the heterocyclyl groups may be benzo-annellated and may be mono- to tri-substituted by identical or different radicals selected from the group consisting of fluorine, chlorine, bromine, nitro, alkoxycarbonyl comprising 1 to 4 carbon atoms in the alkoxy group, cyano, alkyl having 1 to 4 carbon atoms, halogenoalkyl having 1 to 4 carbon atoms and 1 to 5 fluorine, chlorine and/or bromine atoms, alkoxy having 1 to 4 carbon atoms, halogenoalkoxy having 1 to 4 carbon atoms and 1 to 5 fluorine, chlorine and/or bromine atoms, cycloalkyl having 3 to 7 carbon atoms, phenyl and phenoxy.

Very particularly preferred are 7-oxabicyclo[2.2.1]heptadiene derivatives of the formula (I), in which

R¹ represents hydrogen or methyl,

R² represents hydrogen or methyl,

R³ represents a group selected from —OR⁴, —SR⁵ and —NH—R⁶, wherein

R⁴ represents hydrogen, methyl, ethyl, n-propyl, isopropyl, n-butyl, sec-butyl, i-butyl or tert-butyl,

or

R⁴ represents phenyl, which may be mono- to tri-substituted by identical or different radicals selected from the group consisting of fluorine, chlorine, bromine, nitro, cyano, aminocarbonylamino, methyl, ethyl, propyl, isopropyl, n-butyl, iso-butyl, sec.-butyl, tert-butyl, trifluoromethyl, trichloromethyl, chlorodifluoromethyl, methoxy, ethoxy, propoxy, iso-propoxy, n-butoxy, isobutoxy, sec-butoxy, tert-butoxy, trifluoromethoxy, chloro-difluoromethoxy, trichloromethoxy, cyclopropyl, cyclopentyl, cyclohexyl, cycloheptyl, phenyl and phenoxy,

or

R⁴ represents phenylalkyl having 1 to 4 carbon atoms in the alkyl group, wherein the phenyl group may be mono- to tri-substituted identical or different radicals selected from the group consisting of fluorine, chlorine, bromine, nitro, cyano, methyl, ethyl, propyl, isopropyl, n-butyl, iso-butyl, sec.-butyl, tert-butyl, trifluoromethyl, trichloromethyl, chlorodifluoromethyl, methoxy, ethoxy, propoxy, iso-propoxy, n-butoxy, iso-butoxy, sec-butoxy, tert-butoxy, trifluoromethoxy, chloro-difluoromethoxy, trichloromethoxy, cyclopropyl, cyclopentyl, cyclo-hexyl, cycloheptyl, phenyl and phenoxy,

or

R⁴ represents thienyl, furyl, pyrrolyl, pyrazolyl, imidazolyl, thiazolyl, isothiazolyl, oxazolyl, isoxazolyl, oxadiazolyl, thiadiazolyl, 1,2,3-triazinyl, 1,2,4-triazinyl, 1,3,4-triazinyl, pyridyl, pyrimidinyl, pyrazinyl or pyridazinyl, benzothiazolyl, benzoxazolyl or benzimidazolyl, wherein these heterocyclic groups may be mono- to tri-substituted by identical or different radicals selected from the, group consisting of fluorine, chlorine, bromine, nitro, methoxycarbonyl, ethoxycarbonyl, cyano, methyl, ethyl, propyl, isopropyl, n-butyl, iso-butyl, sec.-butyl, tert-butyl, trifluorompethyl, trichloromethyl, chloro-difluoromethyl, methoxy, ethoxy, propoxy, iso-propoxy, n-butoxy, iso butoxy, sec-butoxy, tert-butoxy, trifluoromethoxy, chloro-difluoromethoxy, trichloromethoxy, cyclopropyl, cyclopentyl, cyclo-hexyl, cycloheptyl, phenyl and phenoxy,

or

R⁴ represents a group of the formula -A-R⁷,

wherein

A represents straight-chain or branched allylene having 1 to 4 carbon atoms and

R⁷ represents thienyl, furyl, pyrrolyl, pyrazolyl, imidazolyl, thiazolyl, isothiazolyl, oxazolyl, isoxazolyl, oxadiazolyl, thiadiazolyl, 1,2,3-triazinyl, 1,2,4-triazinyl, 1,3,4-triazinyl, pyridyl, pyrimidinyl, pyrazinyl, pyridazinyl, benzothiazolyl, benzoxazolyl or benzimidazolyl, wherein these heterocyclic groups may be mono- to tri-substituted by identical or different radicals selected from the group consisting of fluorine, chlorine, bromine, nitro, methoxycarbonyl, ethoxycarbonyl, 30 cyano, methyl, ethyl, propyl, isopropyl, n-butyl, iso-butyl, sec.-butyl, tert-butyl, trifluoromethyl, trichloromethyl, chloro-difluoromethyl, methoxy, ethoxy, propoxy, iso-propoxy, n-butoxy, iso-butoxy, sec-butoxy, tert-butoxy, trifluromethoxy, chlorodifluoromethoxy, trichloromethoxy, cyclopropyl, cyclopentyl, cyclohexyl, cycloheptyl, phenyl and phenoxy,

R⁵ represents hydrogen, methyl, ethyl, n-propyl, isopropyl, n-butyl, sec.-butyl, i-butyl or tert-butyl,

or

R⁵ represents phenyl, which may be mono- to tri-substituted by identical or different radicals selected from the group consisting of fluorine, chlorine, bromine, nitro, cyano, aminocarbonylamino, methyl, ethyl, propyl, isopropyl, n-butyl, iso-butyl, sec.-butyl, tert-butyl, trifluoromethyl, trichloromethyl, chlorodifluoromethyl, methoxy, ethoxy, propoxy, iso-propoxy, n-butoxy, iso-butoxy, sec-butoxy, tert-butoxy, trifluoromethoxy, chloro-difluoro-methoxy, trichloromethoxy, cyclopropyl, cyclopentyl, cyclohexyl, cycloheptyl, phenyl and phenoxy,

or

R⁵ represents phenylalkyl having 1 to 4 carbon atoms in the alkyl group, wherein the phenyl group may be mono- to tri-substituted by identical or different radicals selected from the group consisting of fluorine, chlorine, bromine, nitro, cyano, methyl, ethyl, propyl, isopropyl, n-butyl, iso-butyl, sec.-butyl, tert-butyl, trifluoromethyl, trichloromethyl, chlorodifluoromethyl, methoxy, ethoxy, propoxy, iso-propoxy, n-butoxy, iso-butoxy, sec-butoxy, tert-butoxy, trifluoromethoxy, chloro-difluoro-methoxy, trichloromethoxy, cyclopropyl, cyclopentyl, cyclohexyl, cycloheptyl, phenyl and phenoxy,

or

R⁵ represents thienyl, furyl, pyrrolyl, pyrazolyl, imidazolyl, thiazolyl, isothiazolyl, oxazolyl, isoxazolyl, oxadiazolyl, thiadiazolyl, 1,2,3-triazinyl, 1,2,4-triazinyl, 1,3,4-triazinyl, pyridyl, pyrimidinyl, pyrazinyl, pyridazinyl, benzothiazolyl, benzoxazolyl or benzimidazolyl, wherein these heterocyclic groups may be mono- to tri-substituted by identical or different radicals selected from the group consisting of fluorine, chlorine, bromine, nitro, methoxycarbonyl, ethoxycarbonyl, cyano, methyl, ethyl, propyl, isopropyl, n-butyl, iso-butyl, sec.-butyl, tert-butyl, trifluoromethyl, trichloromethyl, chlorodifluoromethyl, meth-oxy, ethoxy, propoxy, iso-propoxy, n-butoxy, iso-butoxy, sec-butoxy, tert-butoxy, trifluoromethoxy, chlorodifluoromethoxy, trichloromethoxy, cyclopropyl, cyclopentyl, cyclohexyl, cycloheptyl, phenyl and phenoxy,

or

R⁵ represents a group of the formula -A-R⁷,

wherein

A represents straight-chain or branched akylene having 1 to 4 carbon atoms and

R⁷ represents thienyl, furyl, pyrrolyl, pyrazolyl, imidazolyl, thiazolyl, isothiazolyl, oxazolyl, isoxazolyl, oxadiazolyl, thiadiazolyl, 1,2,3-trazinyl, 1,2,4-triazinyl, 1,3,4-triazinyl, pyridyl, pyrimidinyl, pyrazinyl, pyridazinyl, benzothiazolyl, benzoxazolyl or benzimidazolyl, wherein these heterocyclic groups may, be mono- to tri-substituted by identical or different radicals selected from the group consisting of fluorine, chlorine, bromine, nitro, methoxycarbonyl, ethoxycarbonyl, cyano, methyl, ethyl, propyl, isopropyl, n-butyl, iso-butyl, sec.-butyl, tert-butyl, trifluoromethyl, trichloromethyl, chloro-difluoromethyl, methoxy, ethoxy, propoxy, iso-propoxy, n-butoxy, iso-butoxy, sec-butoxy, tert-butoxy, trifluoromethoxy, chlorodifluoromethoxy, trichloromethoxy, cyclopropyl, cyclopentyl, cyclohexyl, cycloheptyl, phenyl and phenoxy,

and

R⁶ represents hydrogen, methyl, ethyl, n-propyl, isopropyl, n-butyl, sec-butyl, i-butyl or tert-butyl,

or

R⁶ represents phenyl, which may be mono- to tri-substituted by identical or different radicals selected from the group consisting of fluorine, chlorine, bronine, nitro, cyano, aminocarbonylamino, methyl, ethyl, propyl, isopropyl, n-butyl, iso-butyl, sec.-butyl, tert-butyl, trifluoromethyl, trichloromethyl, chlorodifluoromethyl, methoxy, ethoxy, propoxy, iso-propoxy, n-butoxy, iso-butoxy, sec-butoxy, tert-butoxy, trifluoromethoxy, chloro-difluoro-methoxy, trichloromethoxy, cyclopropyl, cyclopentyl, cyclohexyl, cycloheptyl, phenyl and phenoxy,

or

R⁶ represents phenylalkyl having 1 to 4 carbon atoms in the alkyl group, wherein the phenyl group may be mono- to tri-substituted by identical or different radicals selected from the group consisting of fluorine, chlorine, bromine, nitro, cyano, methyl, ethyl, propyl, isopropyl, n-butyl, iso-butyl, sec.-butyl, tert-butyl, trifluoromethyl, trichloromethyl, chlorodifluoromethyl, methoxy, ethoxy, propoxy, iso-propoxy, n-butoxy, iso-butoxy, sec-butoxy, tert-butoxy, trifluoromethoxy, chloro-difluoromethoxy, trichloromethoxy, cyclopropyl, cyclopentyl, cyclohexyl, cycloheptyl, phenyl and phenoxy,

or

R⁶ represents thienyl, furyl, pyrrolyl, pyrazolyl, imidazolyl, thiazolyl, isothiazolyl, oxazolyl, isoxazolyl, oxadiazolyl, thiadiazolyl, 1,2,3-triazinyl, 1,2,4-triazinyl, 1,3,4-triazinyl, pyridyl, pyrimidinyl, pyrazinyl, pyridazinyl, benzothiazolyl, benzoxazolyl or benzimidazolyl, wherein these heterocyclic groups may be mono- to tri-substituted by identical or different radicals selected from the group consisting of fluorine, chlorine, bromine, nitro, methoxycarbonyl, ethoxycarbonyl, cyano, methyl, ethyl, propyl, isopropyl, n-butyl, iso-butyl, sec.-butyl, tert-butyl, trifluoromethyl, trichloromethyl, chlorodifluoromethyl, methoxy, ethoxy, propoxy, iso-propoxy, n-butoxy, iso-butoxy, sec-butoxy, tert-butoxy, trifluoromethoxy, chlorodifluoromethoxy, trichloromethoxy, cyclopropyl, cyclopentyl, cyclohexyl, cycloheptyl, phenyl and phenoxy,

or

R⁶ represents, a group of the formula -A-R⁷,

wherein

A represents straight-chain or branched alkylene having 1 to 4 carbon atoms and

R⁷ represents thienyl, furyl, pyrrolyl, pyrazolyl, imidazolyl, thiazolyl, isothiazolyl, oxazolyl, isoxazolyl, oxadiazolyl, thiadiazolyl, 1,2,3-triazinyl, 1,2,4-triazinyl, 1,3,4-triazinyl, pyridyl, pyrimidinyl, pyrazinyl, pyridazinyl, benzothiazolyl, benzoxazolyl or benzimidazolyl, wherein these heterocyclic groups may be mono- to tri-substituted by identical or different radicals selected from the group consisting of fluorine, chlorine, bromine, nitro, methoxycarbonyl, ethoxycarbonyl, cyano, methyl, ethyl, propyl, isopropyl, n-butyl, iso-butyl, sec-butyl, tert-butyl, trifluoromethyl, trichloromethyl, chlorodifluoromethyl, methoxy, ethoxy, propoxy, iso-propoxy, n-butoxy, iso-butoxy, sec-butoxy, tert-butoxy, trifluoromethoxy, chlorodifluoromethoxy, trichloromethoxy, cyclopropyl, cyclopentyl, cyclohexyl, cycloheptyl, phenyl and phenoxy.

The 7-oxabicyclo[2.2.1]heptadiene derivatives of the formula (1), which can be used according to the invention, are known in some cases. New 7-oxabicyclo[2.2.1]heptadiene derivatives are those compounds of the formula

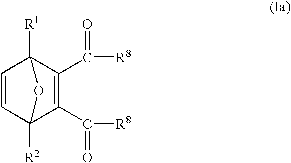

in which

R⁸ represents a group selected from —SR⁵ and —NH—R⁶,

wherein

R⁵ and R⁶, independently of one another, represent hydrogen, alkyl, optionally substituted aryl, optionally substituted aralkyl, optionally substituted heterocyclyl or optionally substituted heterocyclylalkyl.

The 7-oxabicyclo[2.2.1]heptadiene derivatives of the formula (Ia) can be prepared by reacting furan derivatives of the formula

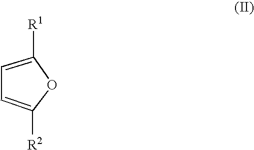

in which

R¹ and R² have the above-mentioned meanings,

with acetylene derivatives of the formula

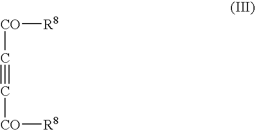

in which

R⁸ has the above-mentioned meanings,

in the presence of a diluent.

The already-known 7-oxabicyclo-[2.2.1]-heptadiene derivatives of the formula (I) can be prepared in the same manner.

Formula (Ia) provides a general definition of the new 7-oxabicyclo-[2.2.1]heptadiene derivatives. Preferred are the compounds of the formula (Ia), in which

R⁸ represents a group selected from —SR⁵ and —NH—R⁶, wherein

R⁵ and R⁶ have the meanings, which have already been mentioned as preferred for these radicals.

Particularly preferred are the compounds of the formula (Ia), in which

R⁸ represents a groups selected from —SR⁵ and —NH—R⁶, wherein

R⁵ and R⁶ have the meanings, which have already been mentioned as particularly preferred for these radicals.

Very particularly preferred are those compounds of the formula (Ia), in which

R⁸ represents a group selected from —SR⁵ and —NH—R⁶, wherein

R⁵ and R⁶ have the meanings which have already been mentioned as very particularly preferred for these radicals.

If furan and acetylene dicarboxylic acid bis-thiobutylate are used as starting materials, the course of the above-mentioned process according to the invention can be illustrated by the following formula scheme.

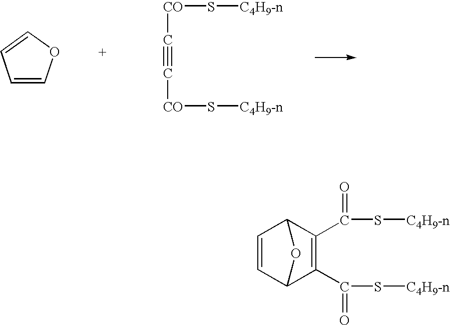

Formulae (II) and (III) provide general definitions of the compounds, which are required as starting materials for carrying out the process according to the invention. In these formulae, the radicals R¹, R² and R⁸ have the meanings, which have already been mentioned as preferred for these radicals.

The compounds of the formulae (II) and (I) are already known or can be prepared by known methods.

Suitable diluents for carrying out the process according to the invention are all customary inert organic solvents. Preference is given to aliphatic, cycloaliphatic or aromatic hydrocarbons and to halogenated aliphatic, cycloaliphatic or aromatic hydrocarbons, such as pentane, hexane, cyclohexane, benzene, toluene, xylene, dichloromethane, trichloromethane, tetrachloromethane and chlorobenzene.

The process according to the invention is preferably carried out under atmospheric pressure.

When carrying out the process according to the invention, the reaction temperatures can be varied within a relatively wide range. In general, the reaction is carried out at temperatures between 0° C. and 120° C., preferably between 20° C. and 100° C.

When carrying out the process according to the invention, the compounds of the formulae (II) and (III) generally are employed in approximately equimolar amounts. However, it is also possible to use an excess of one of the compounds of the formula (I) or (III). Work-up is generally carried out by customary methods.

The compounds according to the invention have a potent microbicidal activity and can be employed for controlling undesirable microorganisms, such as fungi and bacteriae, in crop protection and in the protection of materials. The compounds are suitable for the direct control of undesired microorganisms as well as for generating resistance in plants against attack by undesired microorganisms.

Fungicides are employed in crop protection for controlling Plasmodiophoromycetes, Oomycetes, Chytridiomycetes, Zygomycetes, Ascomycetes, Basidiomycetes and Deuteromycetes.

Bactericides are employed in crop protection for controlling Pseudomonadaceae, Rhizobiaceae, Enterobacteriaceae, Corynebacteriaceae and Streptomycetaceae.

Some pathogens causing fungal and bacterial diseases which come under the generic names listed above are mentioned as examples, but not by way of limitation:

Xanthomonas species, such as, for example, Xanthomonas campestris pv. oryzae;

Pseudomonas species, such as, for example Pseudomonas syringae pv. lachrymans;

Erwinia species, such as, for example, Erwinia amylovora;

Pythium species, such as, for example, Pythium ultimum;

Phytophthora species, such as, for example, Phytophthora infestans;

Pseudoperonospora species, such as, for example, Pseudoperonospora humuli or Pseudoperonospora cubensis;

Plasmopara species, such as, for example, Plasmopara viticola;

Bremia species, such as, for example, Bremia lactucae;

Peronospora species, such as, for example, Peronospora pisi or P. brassicae;

Erysiphe species, such as, for example, Erysiphe graminis;

Sphaerotheca species, such as, for example, Sphaerotheca fuliginea;

Podosphaera species, such as, for example, Podosphaera leucotricha;

Venturia species, such as, for example, Venturia inaequalis;

Pyrenophora species, such as, for example, Pyrenophora teres or P. graminea (conidia form: Drechslera, Syn: Helminthosporium);

Cochliobolus species, such as, for example, Cochliobolus sativus (conidia form: Drechslera, Syn: Helminthosporium);

Uromyces species, such as, for example, Uromyces appendiculatus;

Puccinia species, such as, for example, Puccinia recondita;

Sclerotinia species, such as, for example, Sclerotinia sclerotioruan;

Tilletia species, such as for example, Tilletia caries;

Ustilago species, such as, for example, Ustilago nuda or Ustilago avenae;

Pellicularia species, such as for example, Pellicularia sasakii;

Pyricularia species, such as for example, Pyricularia oiyzae;

Fusarium species, such as, for example, Fusarium culmorum;

Botrytis species, such as, for example, Botrytis cinerea;

Septoria species, such as, for example, Septoria nodorum;

Leptosphaeria species, such as, for example, Leptosphaeria nodorum;

Cercospora species, such as, for example, Cercospora canescens;

Altemaria species, such as, for example, Altemaria brassicae; and

Pseudocercosporella species, such as, for example, Pseudocercosporella herpotrichoides.

The good crop safety of the active compounds at the concentrations necessary for controlling plant diseases permits a treatment of above-ground parts of plants, and also a treatment of vegetative propagation stock and seed and of the soil.

The active compounds according to the invention can be used here particularly successfully for controlling cereal diseases, such as, for example, Erysiphe species.

The active compounds according to the invention are also suitable for increasing the harvest yield. Additionally, they have reduced toxicity and good crop safety.

The active compounds according to the invention additionally have a strong resistance-inducing action in plants. They are therefore suitable for producing resistance in plants to attack by undesired microorganisms.

Resistance-inducing substances are understood in the present context as meaning those substances which on the one hand, when acting directly on the undesired microorganisms, only exhibit a low activity, but are able to stimulate the defense system of plants such that the treated plants, when subsequently inoculated with undesired microorganisms, display extensive resistance to these microorganisms.

Undesired microorganisms are to be understood in the present case as meaning phytopathogenic fungi, bacteriae and viruses. The substances according to the invention can thus be employed in order to produce resistance in plants within a certain period of time after treatment to attack by the harmful causative organisms mentioned. The period of time within which resistance is produced in general extends from 1 to 10 days, preferably 1 to 7 days, after the treatment of the plants with the active compounds.

In the protection of materials, the compounds according to the invention can be employed for protecting industrial materials against infection with, and destruction by, undesired microorganisms.

Industrial materials in the present context are understood as meaning non-living materials which have been prepared for use in industry. For example, industrial materials which are intended to be protected by active compounds according to the invention from microbial change or destruction can be adhesives, sizes, paper and board, textiles, leather, wood, paints and plastic articles, cooling lubricants and other materials which can be infected with, or destroyed by, microorganisms. Parts of production plants, for example cooling-water circuits, which may be impaired by the proliferation of microorganisms may also be mentioned within the scope of the materials to be protected. Industrial materials which may be mentioned within the scope of the present invention are preferably adhesives, sizes, papers and boards, leather, wood, paints, cooling lubricants and heat-transfer liquids, particularly preferably wood.

Microorganisms capable of degrading or changing the industrial materials which may be mentioned are, for example, bacteria, fungi, yeast, algae and slime or organisms. The active compounds according to the invention preferably act against fingi, in particular moulds, wood-discolouring and wood-destroying fungi (Basidiomycetes) and against slime organisms and algae.

Microorganisms of the following genera may be mentioned as examples:

Altemaria, such as Altemaria tenuis,

Aspergillus, such as Aspergillus niger,

Chaetomium, such as Chaetomium globosum,

Coniophora, such as Coniephora puetana,

Lentinus, such as Lentinus tigrinus,

Penicillium, such as Penicillium glaucum,

Polyporus, such as Polyporus versicolor,

Aureobasidium, such as Aureobasidium pullulans,

Sclerophoma, such as Sclerophoma pityophila,

Trichoderma, such as Trichoderma viride,

Escherichia, such as Escherichia coli,

Pseudomonas, such as Pseudomonas aeruginosa,

Staphylococcus, such as Staphylococcus aureus,

The active compounds which can be used according to the invention are well tolerated by plants and have favourable homeotherm toxicity, and they can additionally be employed for controlling animal pests, in particular insects, arachnids and nematodes, which are encountered in agriculture, in forests, in horticulture, in the protection of stored products and of materials and also in the hygiene sector and in the veterinary field. The substances are active against normally sensitive and resistant species and also against pests in all or specific stages of development. The above-mentioned animal pests include:

From the order of the Isopoda, for example, Oniscus asellus, Axmadillidium vulgare and Porcellio scaber.

From the order of the Diplopoda, for example, Blaniulus guttulatus.

From the order of the Chilopoda, for example, Geophilus carpophagus and Scutigera spec.

From the order of the Symphyla, for example, Scutigerella inmmaculata.

From the order of the Thysanura, for example, Lepisma saccharina.

From the order of the Collembola, for example, Onychiurus armatus.

From the order of the Orthoptera, for example, Blatta orientalis, Periplaneta americana, Leucophaea maderae, Blattella germanica, Acheta domesticus, Gryllotalpa spp., Locusta migratoria migratorioides, Melanoplus differentialis and Schistocerca gregana.

From the order of the Dermaptera, for example, Forficula auricularia.

From the order of the Isoptera, for example, Reticulitermes spp.

From the order of the Anoplura, for example, Pediculus humanus corporis, Haematopinus spp. and Linognathus spp.

From the order of the Mallophaga, for example, Trichodectes spp. and Damalinea spp.

From the order of the Thysanoptera, for example, Hercinothrips femoralis and Thrips tabaci.

From the order of the Heteroptera, for example, Eurygaster spp., Dysdercus intermedius, Piesma quadrata, Cimex lectularius, Rhodnius prolixus and Triatoma spp.

From the order of the Homoptera, for example, Aleurodes brassicae, Bemisia tabaci, Trialeurodes vaporariorum, Aphis gossypii, Brevicoryne brassicae, Cryptomyzus ribis, Aphis fabae, Aphis pomi, Eriosoma lanigerum, Hyalopterus arundinis, Phylloxera vastatrix, Pemphigus spp., Macrosiphum avenae, Myzus spp., Phorodon humuli, Rhopalosiphum padi, Empoasca spp., Euscelis bilobatus, Nephotettix cincticeps, Lecanium corni, Saissetia oleae, Laodelphax striatellus, Nilaparvata lugens, Aonidiella aurantii, Aspidiotus hederae, Pseudococcus spp. and Psylla spp.

From the order of the Lepidoptera, for example, Pectinophora gossypiella, Bupalus piniarius, Cheimatobia brumata, Lithocolletis blancardella, Hyponomeuta padella, Plutella maculipennis, Malacosoma neustria, Euproctis chrysorrhoea, Lymantria spp., Bucculatrix thurberiella, Phyllocnistis citrella, Agrotis spp., Euxoa spp., Feltia spp., Earias insulana, Heliothis spp., Spodoptera exigua, Mamestra brassicae, Panolis flammea, Spodoptera litura, Spodoptera spp., Trichoplusia ni, Carpocapsa pomonella, Pieris spp., Chilo spp., Pyrausta nubilalis, Ephestia kuehiniella, Galleria mellonella, Tineola bisselliella, Tinea pellionella, Hofmannophila pseudospretella, Cacoecia podana, Capua reticulana, Choristoneura fumifetana, Clysia ambiguella, Homona magnanima and Tortrix viridana.

From the order of the Coleoptera, for example, Anobium punctatum, Rhizopertha dominica, Bruchidius obtectus, Acanthoscelides obtectus, Hylotrupes bajulus, Agelastica alni, Leptinotarsa decemlineata, Phaedon cochleariae, Diabrotica spp., Psylliodes chrysocephala, Epilachna varivestis, Atomaria spp., Oryzaephilus surinamensis, Anthonomus spp., Sitophilus spp., Otiorrhynchus sulcatus, Cosmopolites sordidus, Ceuthorrhynchus assimilis, Hypera postica, Dermestes spp., Trogoderma spp., Anthrenus spp., Attagenus spp., Lyctus spp., Meligethes aeneus, Ptinus spp., Niptus hololeucus, Gibbium psylloides, Tribolium spp., Tenebrio molitor, Agriotes spp., Conoderus spp., Melolontha melolontha, Amphimallon solstitialis and Costelytra zealandica.

From the order of the Hymenoptera, for example, Diprion spp., Hoplocampa spp., Lasius spp., Monomorium pharaonis and Vespa spp.

From the order of the Diptera, for example, Aedes spp., Anopheles spp., Culex spp., Drosophila melanogaster, Musca spp., Fannia spp., Calliphora erythrocephala, Lucilia spp., Chrysomyia spp., Cuterebra spp., Gastrophilus spp., Hyppobosca spp., Stomoxys spp., Oestrus spp., Hypoderma spp., Tabanus spp., Tannia spp., Bibio hortulanus, Oscinella frit, Phorbia spp., Pegomyia hyoscyami, Ceratitis capitata, Dacus oleae and Tipula paludosa.

From the order of the Siphonaptera, for example, Xenopsylla cheopis and Ceratophyllus spp.

From the order of the Arachnida, for example, Scorpio maurus and Latrodectus mactans.

From the order of the Acarina, for example, Acarus siro, Argas spp., Ornithodoros spp., Dennanyssus gallinae, Eriophyes ribis, Phyliocoptruta oleivora, Boophilus spp., Rhipicephalus spp., Amblyomma spp., Hyalomma spp., Ixodes spp., Psoroptes spp., Chorioptes spp., Sarcoptes spp., Tarsonemus spp., Bryobia praetiosa, Panonychus spp. and Tetranychus spp.

The phytoparasitic nematodes include Pratylenchus spp., Radopholus similis, Ditylenchus dipsaci, Tylenchulus semipenetrans, Heterodera spp., Globodera spp., Meloidogyne spp., Aphelenchoides spp., Longidorus spp., Xiphinema spp. and Trichodorus spp.

The substances which can be used according to the invention can be employed 5 particularly successfully for controlling plant-damaging mites, such as against the greenhouse red spider mite (Tetranychus urticae), or for controlling plant-damaging insects, such as against the green rice leaf hopper (Nephotettix cincticeps).

In some cases, the compounds according to the invention do also show a herbidical activity.

Depending on their particular physical and/or chemical properties, the active compounds can be converted to the customary formulations, such as solutions, emulsions, suspensions, powders, foams, pastes, granules, aerosols and micro-encapsulations in polymeric substances and in coating compositions for seeds, and ULV cool and warm fogging formulations.

These formulations are produced in a known manner, for example by mixing the active compounds with extenders, that is, liquid solvents, liquefied gases under pressure, and/or solid carriers, optionally with the use of surfactants, that is emulsifiers and/or dispersants, and/or foam formers. If the extender used is water, it is also possible to use, for example, organic solvents as auxiliary solvents. Suitable liquid solvents are essentially: aromatics such as xylene, toluene or alkyl-naphthalenes, chlorinated aromatics or chlorinated aliphatic hydrocarbons such as chlorobenzenes, chloroethylenes or methylene chloride, aliphatic hydrocarbons such as cyclohexane or paraffins, for example petroleum fractions, alcohols such as butanol or glycol and their ethers and esters, ketones such as acetone, methyl ethyl ketone, methyl isobutyl ketone or cyclohexanone, strongly polar solvents such as dimethylformamide or dimethyl sulphoxide, or else water. Liquefied gaseous extenders or carriers are to be understood as meaning liquids which are gaseous at standard temperature and under atmospheric pressure, for example aerosol propellants such as halogenated hydrocarbons, or else butane, propane, nitrogen and carbon dioxide. Suitable solid carriers are: for example ground natural minerals such as kaolins, clays, talc, chalk, quartz, attapulgite, montmorillonite or diatomaceous earth, and ground synthetic minerals such as highly disperse silica, alumina and silicates. Suitable solid carriers for granules are: for example crushed and fractionated natural rocks such as calcite, marble, pumice, sepiolite and dolomite, or else synthetic granules of inorganic and organic meals, and granules of organic material such as sawdust, coconut shells, maize cobs and tobacco stalks. Suitable emulsifiers and/or foam formers are: for example nonionic and anionic emulsifiers, such as polyoxyethylene fatty acid esters, polyoxyethylene fatty alcohol ethers, for example alkylaryl polyglycol ethers, alkylsulphonates, alkyl sulphates, arylsulphonates, or else protein hydrolysates. Suitable dispersants are: for example lignin-sulphite waste liquors and methylcellulose.

Tackifiers such as carboxymethylcellulose and natural and synthetic polymers in the form of powders, granules or latices, such as gum arabic, polyvinyl alcohol and polyvinyl acetate, or else natural phospholipids such as cephalins and lecithins and synthetic phospholipids, can be used in the formulations. Other possible additives are mineral and vegetable oils.

It is possible to use colorants such as inorganic pigments, for example iron oxide, titanium oxide and Prussian Blue, and organic dyestuffs such as alizarin dyestuffs, azo dyestuffs and metal phthalocyanine dyestuffs, and trace nutrients such as salts of iron, manganese, boron, copper, cobalt, molybdenum and zinc.

The formulations generally comprise between 0.1 and 95, percent by weight of active compound, preferably between 0.5 and 90%.

The active compounds according to the invention can be used as such or in their formulations also mixed with known fungicides, bactericides, acaricides, nematicides or insecticides in order thus, for example, to widen the spectrum of action or to prevent development of resistance. In many cases, synergistic effects are achieved, i.e. the activity of the mixture exceeds the activity of the individual components. Examples of co-components in mixtures are the following compounds:

Fungicides:

aldimorph, ampropylfos, amppropylfos potassium, andoprim, anilazine, azaconazole, azoxystrobin,

benalaxyl, benodanil, benomyl, benzamacril, benzamacril-isobutyl, bialaphos, binapacryl, biphenyl, bitertanol, blasticidin-S, bromuconazole, bupirimate, buthiobate,

calcium polysulphide, capsimycin, captafol, captan, carbendazim, carboxin, carvon, quinomethionate, chlobenthiazone, chlorfenazole, chloroneb, chloropicrin, chlorothalonil, chlozolinate, clozylacon, cufraneb, cyinoxanil, cyproconazole, cyprodinil, cyprofuram, carpropamide,

debacarb, dichlorophen, diclobutrazole, diclofluanid, diclomezine, dicloran, diethofencarb, difenoconazole, dimethirimol, dimethomorph, diruconazole, diniconazole-M, dinocap, diphenylamine, dipyrithione, ditalimfos, dithianon, dodemorph, dodine, drazoxolon,

edifenphos, epoxiconazole, etaconazole, ethirimol, etridiazole,

famoxadon, fenapanil, fenarimol, fenbuconazole, fenfuram, fenitropan, fenpiclonil, fenpropidin, fenpropimorph, fentin acetate, fentin-hydroxide, ferbam, ferimzone, fluazinam, flumetover, fluoromide, fluquinconazole, flurprimidol, flusilazole, flusulfamide, flutolanil, flutriafol, folpet, fosetyl-aluminium, fosetyl-sodium, fthalide, fuberidazole, furalaxyl, furarnetpyr, furcarbonil, furconazole, furconazole-cis, fuirecyclox, fenhexamide,

guazatine,

hexachlorobenzene, hexaconazole, hymexazoleimazalil,

imibenconazole, iminoctadine, nimnoctadine albesilate, iminoctadine triacetate, iodocarb, ipconazole, iprobenfos (IBP), iprodione, irumamycin, isoprothiolane, isovaledione, iptovalicaib,

kasugamycin, kresoxim-methyl, copper preparations, such as: copper hydroxide, copper naphthenate, copper oxychloride, copper sulphate, copper oxide, oxine-copper and Bordeaux mixture,

mancopper, mancozeb, maneb, meferinzone, mepanipyrim, mepronil, metalaxyl, metconazole, methasulfocarb, methfuroxam, metiram, metomeclam, metsulfovax, mildiomycin, myclobutanil, miyclozolin,

nickel dimethyldithiocarbamate, nitrothal-isopropyl, nuarimol,

ofurace, oxadixyl, oxamocarb, oxolinic acid, oxycarboxim, oxyfenthiin,

paclobutrazole, pefurazoate, penconazole, pencycuron, phosdiphen, pimaricin, piperalin, polyoxin, polyoxorim, probenazole, prochloraz, procymidone, propamocarb, propanosine-sodium, propiconazole, propineb, pyrazophos, pyrifenox, pyrimethanil, pyroquilon, pyroxyfur,

quinconazole, quintozene (PCNB), quinoxyfen

sulphur and sulphur preparations, spiroxamine,

tebuconazole, tecloftalam, tecnazene, tetcyclasis, tetraconazole, thiabendazole, thicyofen, thifluzamide, thiophanate-methyl, thiraam, tioxymid, tolclofos-methyl, tolylfluarud, triadimefon, triadimenol, triazbutil, triazoxide, trichlamide, tricyclazole, tridemorph, triflumizole, triforine, triticonazole, trifloxystrobin,

uniconazole,

validamycin A, vinclozolin, viniconazole,

zarilamide, zineb, ziram and also

Dagger G,

OK-8705,

OK-8801,

α-(1,1-dimethylethyl)-β-(2-phenoxyethyl)-1H-1,2,4-triazole-1-ethanol,

α-(2,4-dichlorophenyl)-β-fluoro-β-propyl-1H-1,2,4-triazole-1-ethanol,

α-(2,4-dichlorophenyl)-β-methoxy-α-methyl-1H-1,2,4-triazole-1-ethanol,

α-(5-methyl-1,3-dioxan-5-yl)-β-[[4-(trifluoromethyl)-phenyl]-methylene]-1H-1,2,4-triazole-1-ethanol,

(5RS,6RS)-6-hydroxy-2,2,7,7-tetramethyl-5-(1H-1,2,4-triazol-1-yl)-3-octanone,

(E)-α-(methoxyimino)-N-methyl-2-phenoxy-phenylacetamide,

1-(2,4-dichlorophenyl)-2-(1H 1,2,4-triazol-1-yl)-ethanone-O-(phenylmethyl)-oxime,

1-(2-methyl-1-naphthalenyl)-1H-pyrrole-2,5-dione,

1-(3,5-dichlorophenyl)-3-(2-propenyl)-2,5-pyrrolidinedione,

1-[(diiodomethyl)-suiphonyl]-4-methyl-benzene,

1-[[2-(2,4-dichlorophenyl)-11,3-dioxolan-2-yl]-methyl]1H-imidazole,

1[[2-(4-chlorophenyl)-3-phenyloxiranyl]-methyl] 1H-1,2,4-triazole,

1-[1−[2-[(2,4-dichlorophenyl)-methoxy]-phenyl]-ethenyl]-1H-imidazole,

1-methyl-5-nonyl-2-(phenylmethyl)-3-pyrrolidinole,

2′,6′-dibromo-2-methyl-4′-trifluoromethoxy-4′-trifluoro-methyl-1,3-thiazole-5-carboxanilide,

2,6-dichloro-5-(methylthio)-4-pyrimidinyl-thiocyanate,

2,6-dichloro-N-(4-trifuoromethylbenzyl)-benzamide,

2,6-dichloro-N-[[4-(trifluoromnethyl)-phenyl]-methyl]-benzamide,

2-(2,3,3-triiodo-2-propenyl)-2H-tetrazole,

2-[(1-methylethyl)-sulphonyl]-5-(trichloromethyl)-1,3,4-tlaiadiazole,

2-[[6-deoxy4-O-(4O-methyl-β-D-glycopyranosyl)-α-D-glucopyraniosyl]-amino]4-methoxy-1H-pyrrolo[2,3-d]pyrimidine-5-carbonitrile,

2-amnobutane,

2-bromo-2-(bromomethyl)-pentanedintrile,

2-chloro-N-(2,3-dihydro-1,1,3-trimethyl-1H-inden-4-yl)-3-pyridinecarboxamide,

2-chloro-N-(2,6-dimethylphenyl)-N-(isothiocyanatomethyl)-acetamide,

2-phenylphenol (OPP),

3,4-dichloro-1-[4-(difluoromethoxy)-phenyl]-1H-pyrrole-2,5-dione,

3,5-dichloro-N-[cyano-[(1-methyl-2-propinyl)-oxy]-methyl]-benzamide,

3-(1,1-dimethylpropyl-1-oxo-1H-indene-2-carbonitrile,

3-[2-(4-chlorophenyl)-5-ethoxy-3-isoxazolidinyl]-pyridine,

4-chloro-2-cyano-N,N-dimnethyl-5-(4-methylphenyl)1H-imidazole-1-sulphonamide,

4-methyl-tetrazolo[1,5-a]quinazolin-5(4H)-one,

8-hydroxyquinoline sulphate,

9H-xanthene-2-[(phenylamiino)carbonyl]-9-carboxylic hydrazide,

bis-(1−methylethyl)-3-methyl-4-[(3-methylbenzoyl)-oxy]-2,5-thiophenedi-carboxylate,

cis-1-(4-chlorophenyl)-2-(1H-1,2,4-triazol-1-yl)-cycloheptanol,

cis-4-[3-[4-(1,1-dimethylpropyl)-phenyl-2-methylpropyl]-2,6-dimethyl-morpholine-hydrochloride,

ethyl [(4-chlorophenyl)-azo]-cyanoacetate,

potassium hydrogen carbonate,

methanetetrathiol sodium salt,

methyl 1-(2,3-dihydro-2,2-dimethyl-1H-inden-1-yl)-1H-imidazole-5-carboxylate,

methyl N-(2,6-dimethylphenyl)-N-(5-isoxazolylcarbonyl)-DL-alaninate,

methyl N-(chloroacetyl)-N-(2,6-dimethylphenyl)-DL-alaninate,

N-(2,6-dimethylphenyl)-2-methoxy-N-(tetrahydro-2-oxo-3-furanyl)-acetamide,

N-(2,6-dimethylphenyl)-2-methoxy-N-(tetrahydro-2-oxo-3-thienyl)-acetamide,

N-(2-chloro4-nitrophenyl)-4-methyl-3-nitro-benzenesulphonamide,

N-(4-cyclohexylphenyl)-1,4,5,6-tetrahydro-2-pyrimidineamide,

N-(4-hexylphenyl)-1,4,5,6-tetrahydro-2-pyrimidineamine,

N-(5-chloro-2-methylphenyl)-2-methoxy-N-(2-oxo-3-oxazolidinyl)-acetamide,

N-(6-methoxy)-3-pyridinyl)-cyclopropanecarboxamide,

N-[2,2,2-trichloro-1-[(chloroacetyl)-amino]-ethyl]-benzamide,

N-[3-chloro-4,5-bis-(2-propinyloxy)-phenyl]-N′-methoxy-methaneimidamide,

N-formyl-N-hydroxy-DL-alanine-sodium salt,

O,O-diethyl [2-(dipropylamino)-2-oxoethyl]-ethylphosphoramidothioate,

O-methyl S-phenyl phenylpropylphosphoramidothioate,

S-methyl 1,2,3-benzothiadiazole-7-carbothioate,

spiro[2H]-1-benzopyrane-2,1′(3′H)-isobenzofuran]-3′-one.

Bactericides:

bromopol, dichlorophen, nitrapyrin, nickel dimethyldithiocarbamate, kasugamycin, octhilinone, furancarboxylic acid, oxytetracyclin, probenazole, streptomycin, tecloftalam, copper sulphate and other copper preparations.

Insecticides/Acaricides/Nematicides:

abamectin, acephate, acrinathrin, alanycarb, aldicarb, alphamethrin, amitraz, avermectin, AZ 60541, azadirachtin, azinphos A, azinphos M, azocyclotin, Bacillus thuringiensis, 4-bromo-2-(4-chlorophenyl)-1-(ethoxymethyl)-5-(trifluoromethyl)-1H-pyrrole-3-carbonitrile,

bendiocarb, benfuracarb, bensultap, betacyfluthrin, bifenthrin, BPMC, brofenprox, bromophos A, bufencarb, buprofezin, butocarboxin, butylpyridaben,

cadusafos, carbaryl, carbofuran, carbophenothion, carbosulfan, cartap, chloethocarb, chlorethoxyfos, chlorfenapyr, chlorfenvinphos, chlorfluazuron, chlormephos, N-[(6-chloro-3-pyridinyl)-methyl]-N′-cyano-N-methyl-ethaneimidamide, chlorpyrifos, chlorpyrifos M, cis-resmethrin, clocythrin, clofentezine, cyanophos, cycloprothrin, cyfluthrin, cyhalothrin, cyhexatin, cypermethrin, cyromazine,

deltamethrin, demeton M, demeton S, demeton S-methyl, diafenthiuron, diazinon, dichlofenthion, dichlorvos, dicliphos, dicrotophos, diethion, diflubenzuron, dimethoate, dimethylvinphos, dioxathion, disulfoton,

emamectin, esfenvalerate, ethiofencarb, ethion, ethofenprox, ethoprophos, etrimphos,

fenamiphos, fenazaquin, fenbutatin oxide, fenitrothion, fenobucarb, fenothiocarb, fenoxycarb, fenpropathrin, fenpyrad, fenpyroximate, fenthion, fenvalerate, fipronil, fluazuron, flucycloxuron, flucythrinate, flufenoxuron, flufenprox, fluvalinate, fonophos, formothion, fosthiazate, fubfenprox, fiurathiocarb,

HCH, heptenophos, hexaflumuron, hexytinazox,

imidacloprid, isazophos, isofenphos, isoprocarb, isoxathion, ivermectin,

lambda-cyhalothrin, lufenuron,

malathion, mecarbam, mervinphos, mesulfenphos, metaldehyde, methacrifos, methamidophos, methidathion, methiocarb, methomyl, metolcarb, milbemectin, monocrotophos, moxidectin,

naled, NC 184, nitenpyram,

omethoate, oxamyl, oxydemethon M, oxydeprofos,

parathion A, parathion M, permethrin, phenthoate, phorate, phosalone, phosmet, phosphamidon, phoxim, pirimicarb, pirimiphos' M, piriiphos A, profenofos, promecarb, propaphos, propoxur, prothiofos, prothoate, pymetrozin, pyrachlophos, pyridaphenthion, pyresmethrin, pyrethrum, pyridaben, pyrirmidifen, pyriproxifen,

quinalphos,

salithion, sebufos, silafluofen, sulfotep, sulprofos,

tebufenozide, tebufenpyrad, tebupirimiphos, teflubenzuron, tefluthrin, temephos, terbam, terbufos, tetrachlorvinphos, thiafenox, thiamethoxam, thiodicarb, thiofanox, thiomethon, thionazin, thuringiensin, tralomethrin, triarathen, triazophos, triazuron, trichlorfon, triflumuron, trimethacarb,

vamridothion, XMC, xylylcarb, zetamethrin.

It is also possible to admix other known active compounds, such as herbicides, or else fertilizers and growth-promoting substances.

The active compounds can be used as such, in the form of their formulations or the use forms prepared therefrom, such as ready-to-use solutions, suspensions, wettable powders, pastes, soluble powders, dusts and granules. They are used in the customary manner, for example by pouring, spraying, atomizing, spreading, dusting, foaming, brushing on and the like. It is further possible to apply the active compounds by the ultra-low volume method or to inject the active compound formulation, or the active compound itself, into the soil. The seed of the plants can also be treated.

When using the active compounds according to the invention for controlling microorganisms, the application rates can be varied within a relatively wide range, depending on the kind of application. When treating parts of plants, the active compound application rates are generally between 0.1 and 10,000 g/ha, preferably between 10 and 1000 g/ha. When treating seed, the active compound application rates are generally between 0.001 and 50 g per kilogram of seed, preferably between 0.01 and 10 g per kilogram of seed. When treating the soil, the active compound application rates are generally between 0.1 and 10,000 g/ha, preferably between 1 and 5000 g/ha.

The compositions used for the protection of industrial materials generally comprise an amount of from 1 to 95%, preferably from 10 to 75%, of the active compounds.

The use concentrations of the active compounds according to the invention depend on the species and the occurrence of the microorganisms to be controlled and on the composition of the material to be protected. The optimal rate of application can be determined by test series. In general, the use concentrations are in the range from 0.001 to 5% by weight, preferably from 0.05 to 1.0% by weight, based on the material to be protected.

It is possible to increase the activity and the activity spectrum of the active compounds which are to be used according to the invention in the protection of materials, or of the compositions, concentrates or quite generally formulations which can be prepared from these, by adding, if appropriate, other compounds having antimicrobial action, fungicides, bactericides, herbicides, insecticides or other active compounds for increasing the activity spectrum or for obtaining special effects such as, for example, additional protection against insects. These mixtures may have a Wider activity spectrum than the compounds according to the invention.

When used against animal pests, too, the substances which can be used according to the invention, in commercially available formulations and also in the use forms prepared from these formulations, can be present as a mixture with synergists. Synergists are compounds which enhance the effectiveness of the active compounds, without it being necessary for the synergist which is added to be active itself.

The content of active compound in the use forms prepared from the commercially available formulations can vary within wide ranges. The concentration of active compound in the use forms can be from 0.0000001 to 95% by weight of active compound, preferably between 0.0001 and 1% by weight.

Application is carried out in a manner which is appropriate for the use forms.

The preparation and the use of the compounds according to the invention are illustrated by the examples which follow.

### PREPARATION EXAMPLES

### Examples 1

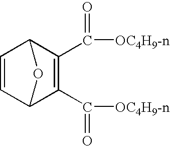

1.3 g of furan were added to a solution of 4.3 g of acetylene dicarboxylic acid bis-n-butyl-ester in 20 ml of dichloromethane at room temperature. The mixture was then heated under reflux for 6 hours. After cooling to room temperature, the solvent was distilled off under reduced pressure. The remaining oily product was purified by chromatography over a silica gel column by using a mixture of ligroin/ethylacetate=5:1 as the liquid phase. After concentrating the eluate under reduced pressure, 1.7 g (=30.4% of theory) of the compound of the formula shown above were obtained in the form of a yellow liquid having a refractive index of

$${n}_{20}^{D} = 1.4779 .$$

Preparation of the Starting Material of the Formula

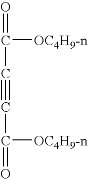

30 g of concentrated sulfuric acid were added in small portions to 100 ml of n-butanol at a temperature between 0 and 11° C. whilst stirring. 15.2 g of potassium salt of acetylenedicarboxylic acid were then added, and the reaction mixture was vigorously stirred for 7 days at room temperature. The liquid phase was then decanted, and the remaining inorganic salt was washed with 200 ml of cold water. The liquid phases were combined and extracted with 200 ml of ethylacetate. The organic phase was subsequently washed with cold water, with a saturated, aqueous sodium carbonate solution and with cold water. After drying over anhydrous sodium sulphate, the solvent was evaporated under reduced pressure. The remaining product was purified by chromatography over a silica gel column by using a mixture of ligroin/ethylacetate 5:1 as the liquid phase. After concentrating the eluate under reduced pressure, 8.9 g (=30.4% of theory) of acetylene dicarboxylic acid bis-n-butyl-ester were obtained in the form of a yellow liquid.

The compounds shown in the following Table 1 were also prepared by the above-mentioned method.

TABLE 1

| | |
|---|---|
| | (I) |
| 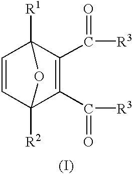 | |

| Example | | | | Physical |
|---|---|---|---|---|
| No. | R¹ | R² | R³ | Constant |
| 2 | H | H | —OC₂H₅ | n₂₀^{D} = 1.4862 |
| 3 | —CH₃ | H | —OC₂H₅ | n₂₀^{D} = 1.4780 |
| 4 | H | H | —OCH₃ | m.p. 118-119° C. |
| 5 | —CH₃ | , —CH₃ | —OCH₃ | n₂₃^{D} = 1.4700 |
| 6 | —CH₃ | H | —OCH₃ | n₂₃^{D} = 1.4828 |
| 7 | —CH₃ | —CH₃ | —OC₂H₅ | n₂₀^{D} = 1.4629 |
| 8 | —CH₃ | —CH₃ | —OC₄H₉-n | n₂₀^{D} = 1.4668 |
| 9 | —CH₃ | —CH₃ | —OC₃H₇-n | n₂₀^{D} = 1.4658 |
| 10 | H | H | —OC₃H₇-n | n₂₀^{D} = 1.4807 |
| 11 | —CH₃ | H | —OC₃H₇-n | n₂₀^{D} = 1.4783 |
| 12 | —CH₃ | H | —OC₄H₉-n | n₂₀^{D} = 1.4698 |

### USE EXAMPLES

### Example A

Erysiphe Test (Barley)/Induction of Resistance

Solvent: 50 parts by weight of N,N-dimethylformamide

Emulsifier: 1.17 parts by weight of alkylaryl polyglycol ether

To produce a suitable preparation of active compound, 0.1 part by weight of active compound is mixed with the stated amount of solvent, and the concentrate is diluted with water and the stated amount of emulsifier to the desired concentration.

To test for resistance-inducing activity, young barley plants are sprayed with the preparation of active compound at the stated rate of application. 4 days after the treatment, the plants are inoculated with an aqueous spore suspension of. Erysiphe graminis f. sp.hordei. The plants are subsequently placed in a greenhouse at 70% relative atmospheric humidity and 18° C.

The test is evaluated 7 days after the inoculation. 0% means an efficacy which corresponds to that of the control while an efficacy of 100% means that no disease is observed.

The active compounds, active compound concentrations and results can be seen from the following table:

TABLE A
Erysiphe test (barley)/induction of resistance

| | Rate of application of | |
|---|---|---|
| Active compound | active compound in g/ha | Efficiacy in % |
| According to the invention: | | |
| 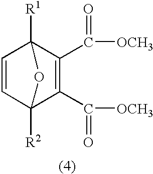 | 750 | 100 |

1. Use of 7-oxabicyclo[2.2.1]heptadiene derivatives of the formula 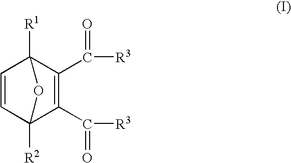
in which
R¹ and R², independently of one another, represent hydrogen or methyl and
R³ represents a group selected from OR⁴, —SR⁵ and —NH—R⁶,
wherein
R⁴, R⁵ and R⁶ independently of one another, represent hydrogen, alkyl, optionally substituted aryl, optionally substituted aralkyl, optionally substituted heterocyclyl or optionally substituted heterocyclylalkyl,
for controlling undesired microorganisms and animal pests.

2. Method for controlling undesired microorganisms and animals pests, characterized in that 7-oxabicyclo[2.2.1]heptadiene derivatives of the formula (1), according to claim 1 are applied to the microorganisms or animal pests or to their habitat.

3. 7-Oxabicyclo[2.2.1]heptadiene derivatives of the formula 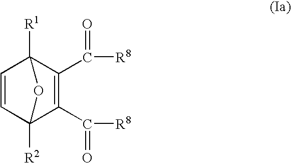
in which
R⁸ represents a group selected from SR⁵ and —NH—R⁶,
wherein
R⁵ and R⁶, independently of one another, represent hydrogen, alkyl, optionally substituted aryl, optionally substituted aralkyl, optionally substituted heterocyclyl or optionally substituted heterocyclylalkyl.

4. Process for the preparation of 0.7-oxabicyclo[2.2.1]heptadiene derivatives of the formula (Ia) according to claim 3, characterized in that furan derivatives of the formula 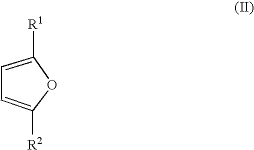
in which
R¹ and R² have the above-mentioned meanings,
are reacted with acetylene derivatives of the formula 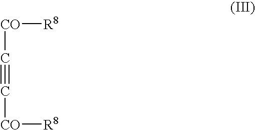
in which
R⁸ has the above-mentioned meanings,
in the presence of a diluent.

5. Microbicidal and pesticidal compositions, characterized by comprising at least one 7-oxabicyclo[2.2.1]heptadiene derivative of the formula (Ia) according to claim 3 in admixture with extenders and/or surface-active agents.

6. Process for the preparation of microbicidal and pesticidal compositions, characterized in that 7-oxabicyclo[2.2.1]heptadiene derivatives of the formula (Ia) according to claim 3 are mixed with extenders and/or surface-active agents.
